(19) United States
(12) Patent Application Publication
(10) Pub. No.: US 2026/0032038 A1
(43) Pub. Date: Jan. 29, 2026

(54) NETWORK SERVICE ASSURANCE PREDICTIVE ANALYSIS SYSTEM AND METHOD

(71) Applicant: AT&T Intellectual Property I, L.P., Atlanta, GA (US)

(72) Inventors: Farhad M. Noori, Alpharetta, GA (US); Jiyuan Wang, Cumming, GA (US); Chandra Cinthala, Suwanee, GA (US); Vikas Varma, Marietta, GA (US); Kumar Tamilmoni, Atlanta, GA (US)

(73) Assignee: AT&T Intellectual Property I, L.P., Atlanta, GA (US)

(21) Appl. No.: 18/784,248

(22) Filed: Jul. 25, 2024

(51) Int. Cl. H04L 41/0604; H04L 43/08

(52) U.S. Cl. CPC H04L 41/0609; H04L 43/08

(57) ABSTRACT

Aspects of the subject disclosure may include, for example, identifying a network service assurance objective and obtaining first network monitoring data indicative of a first operational status of a group of network devices. The first network monitoring data are prioritized according to the network operations objective to obtain first prioritized results and a predictive model is trained based on the first network monitoring data and the first prioritized results. The second monitoring data indicative of a second operational status of the group of network devices are evaluated according to the trained predictive model to obtain second prioritized results, wherein the network monitoring data is prioritized according to the second prioritized results. Other embodiments are disclosed.

### FIELD OF THE DISCLOSURE

The subject disclosure relates to a network service assurance predictive analysis system and method.

### BACKGROUND

Network service assurance is a mission critical infrastructure to promote the integrity, availability, and performance of network services, such as telecommunications, broadband, mobility services. Network service assurance can provide baseline information about network performance, and in at least some instances, support investigations of network issues responsive to reductions in performance levels. For platforms that run many algorithms, rules, and processes, it can be difficult to determine legitimate problems in the network. Unfortunately, these types of complicating factors can result in significant costs associated with the development and maintenance of network service assurance infrastructures.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a network service assurance predictive analysis system functioning within the communication network of FIG. 1 in accordance with various aspects described herein.

FIG. 2B is a block diagram illustrating an example, non-limiting embodiment of another network service assurance predictive analysis system functioning within the communication network of FIG. 1 in accordance with various aspects described herein.

FIG. 2C depicts an illustrative embodiment of a network service assurance predictive analysis process in accordance with various aspects described herein.

FIG. 2D is a block diagram illustrating an example, non-limiting embodiment of a network service assurance predictive analysis development platform functioning within the communication network of FIG. 1 in accordance with various aspects described herein.

FIG. 2E is a block diagram illustrating an example, non-limiting embodiment of a user interface configured for network service assurance predictive analysis functioning within the communication network of FIG. 1 in accordance with various aspects described herein.

FIG. 2F depicts an illustrative embodiment of a network service assurance predictive analysis process in accordance with various aspects described herein.

FIG. 2G depicts an illustrative embodiment of a network service assurance predictive analysis process in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for automating an efficient identification of critical network issues by training a predictive model to address network service assurance (NSA) objectives and subsequently applying the trained model to live network monitoring data to prioritize network monitoring results according to the NSA objectives. Other embodiments are described in the subject disclosure.

One or more aspects of the subject disclosure include a device, having a processing system including a processor and a memory that stores executable instructions that, when executed by the processing system, facilitate performance of operations. The operations include determining a network service assurance (NSA) objective and receiving first network monitoring data indicative of a first operational status of a group of network devices; processing the first network monitoring data according to the NSA objective to obtain a group of first processed results. The operations further include training a model based on the first network monitoring data and the group of the first processed results to obtain a trained model, and processing, according to the trained model, second network monitoring data indicative of a second operational status of the group of network devices to obtain a group of second processed results. The operations still further include prioritizing the second network monitoring data according to the group of the second processed results.

One or more aspects of the subject disclosure include a process that includes determining, by a processing system including a processor, a network operations objective and receiving, by the processing system, first network monitoring data indicative of a first operational status of a group of network devices. The process further includes evaluating, by the processing system, the first network monitoring data according to the network operations objective to obtain a group of first prioritized results and training, by the processing system, a predictive model based on the first network monitoring data and the group of first prioritized results to obtain a trained predictive model. The process still further includes processing, by the processing system and according to the trained predictive model, second monitoring data indicative of a second operational status of the group of network devices to obtain a group of second prioritized results, wherein the network monitoring data is prioritized according to the group of second prioritized results.

One or more aspects of the subject disclosure include a non-transitory machine-readable medium, including executable instructions that, when executed by a processing system including a processor, facilitate performance of operations. The operations include identifying a network operations objective and obtaining first network monitoring data indicative of a first operational status of a group of network devices. The operations further include prioritizing the first network monitoring data according to the network operations objective to obtain first prioritized results and training a predictive model based on the first network monitoring data and the first prioritized results to obtain a trained predictive model. The operations still further include evaluating, according to the trained predictive model, second monitoring data indicative of a second operational status of the group of network devices to obtain second prioritized results, wherein the network monitoring data is prioritized according to the second prioritized results.

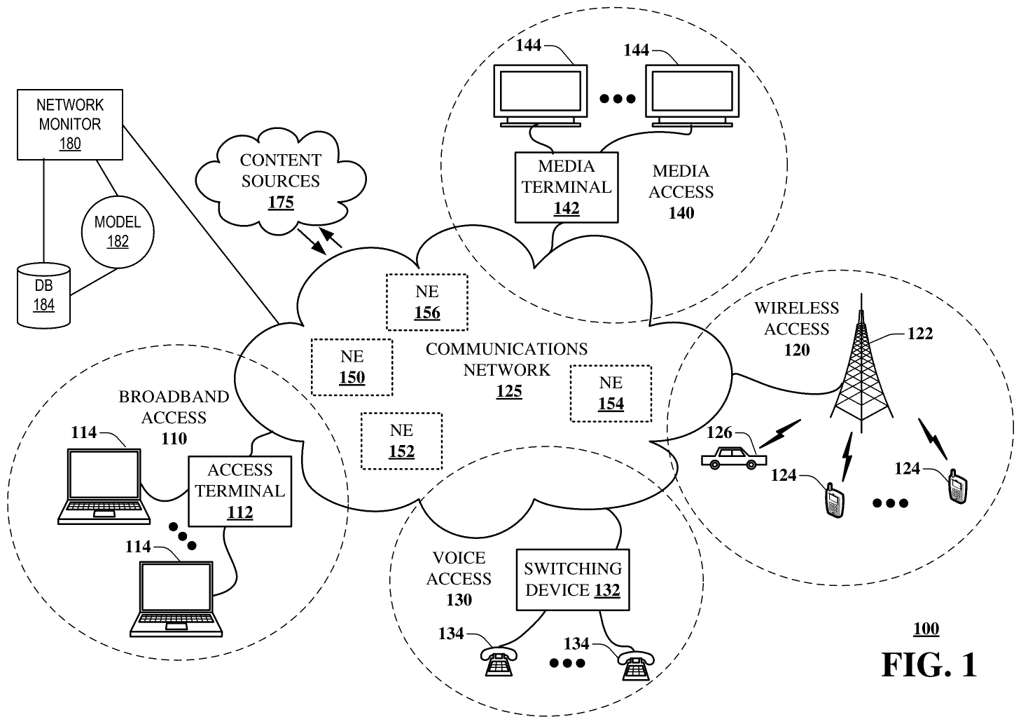

Referring now to FIG. 1, a block diagram is shown illustrating an example, non-limiting embodiment of a communications network 100 in accordance with various aspects described herein. For example, the communications network 100 can facilitate in whole or in part identifying a network service assurance objective and obtaining first network monitoring data indicative of a first operational status of a group of network devices. The first network monitoring data can be prioritized according to the network operations objective to obtain first prioritized results and a predictive model can be trained based on the first network monitoring data and the first prioritized results. The second monitoring data indicative of a second operational status of the group of network devices are evaluated according to the trained predictive model to obtain second prioritized results, wherein the network monitoring data is prioritized according to the second prioritized results. The prioritized results can be obtained quickly and automatically and used to determine any responsive actions as may be necessary to address critical network issues related to the second monitoring data, without having to manually distinguish criticality. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc., for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VOIP gateway or other gateway device and/or other switching device. The telephony devices 134 can include traditional telephones (with or without a terminal adapter), VOIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc., can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

The example communication network 100 includes a network monitor 180, a network alert processing model 182 and an example network data repository 184. The network monitor 180 is in communication with the one or more of the communications network 125, the broadband access network 110, the wireless access network 120, the voice access network 130 and the media access network 140. The network monitor 180 can be configured to receive network monitoring information, such as messages, e.g., alarms, reported by one or more devices or elements of the monitored networks. It is understood that in at least some embodiments, the number of network elements and alarms related thereto can be enormous. It is understood that at least some monitored alarms can require a responsive action to ensure service level assurance (SLA) objectives. Beneficially, the network alert processing model 182 can be configured and/or otherwise trained to process alerts to obtain a prioritization and/or identification of those alerts and/or classes of alerts likely to impact the SLA objectives. Accordingly, a network operator can process excessively large numbers of alerts in order to quickly and in at least some embodiments, automatically, identify a subset of the alarms deemed to be critical, e.g., requiring attention and/or a response. The network data repository 184 can include information in support of such monitoring and analysis, e.g., including one or more of network configuration data, network device or element data, alarm criticality information, historical records of observed alarms and/or reactions thereto, and/or training data as may be beneficially for training the model 182, e.g., when it utilizes artificial intelligence (AI) and/or machine learning (ML).

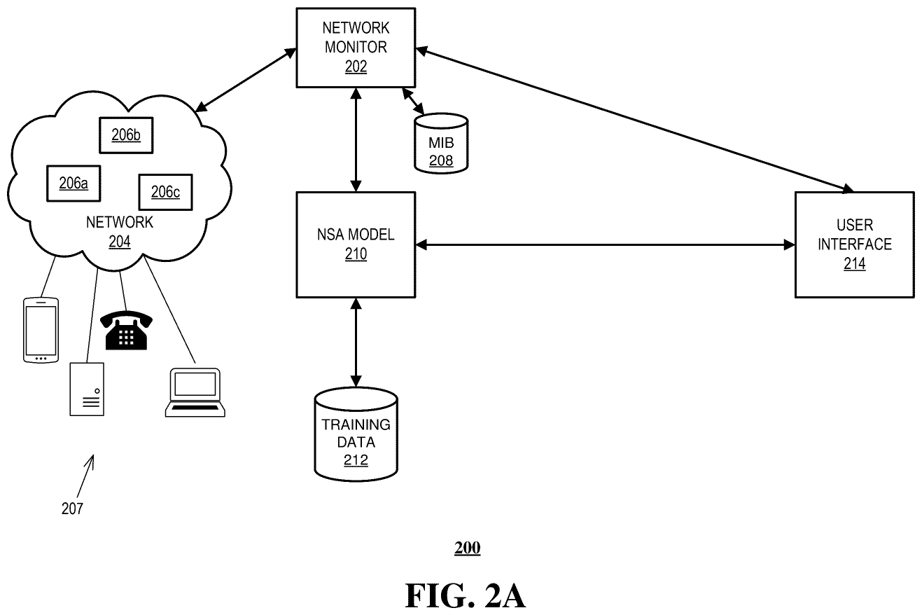

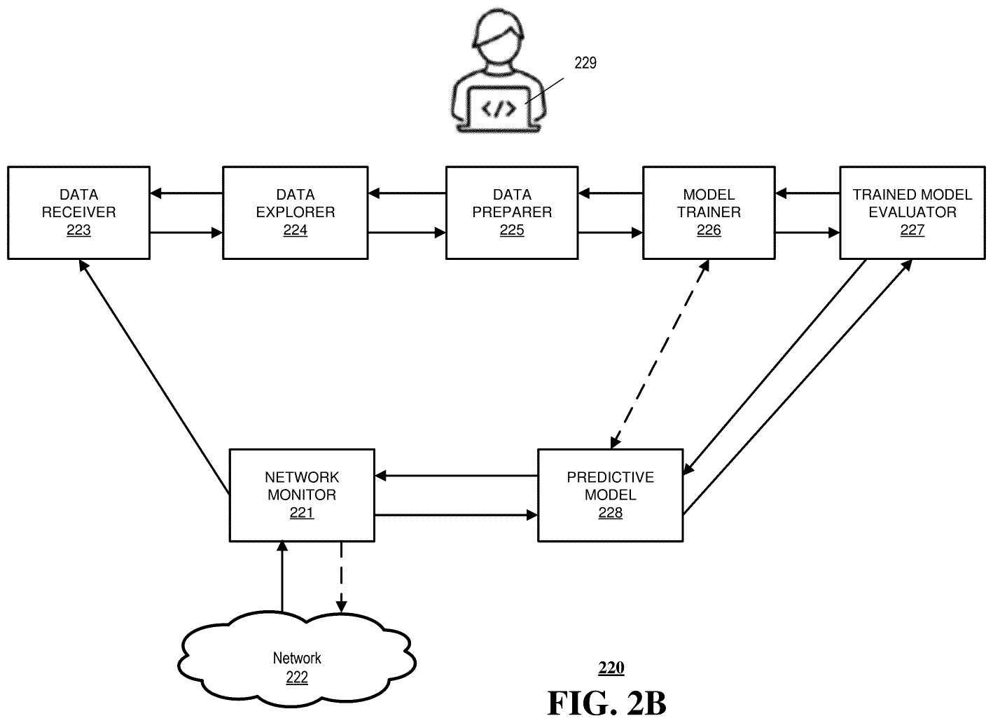

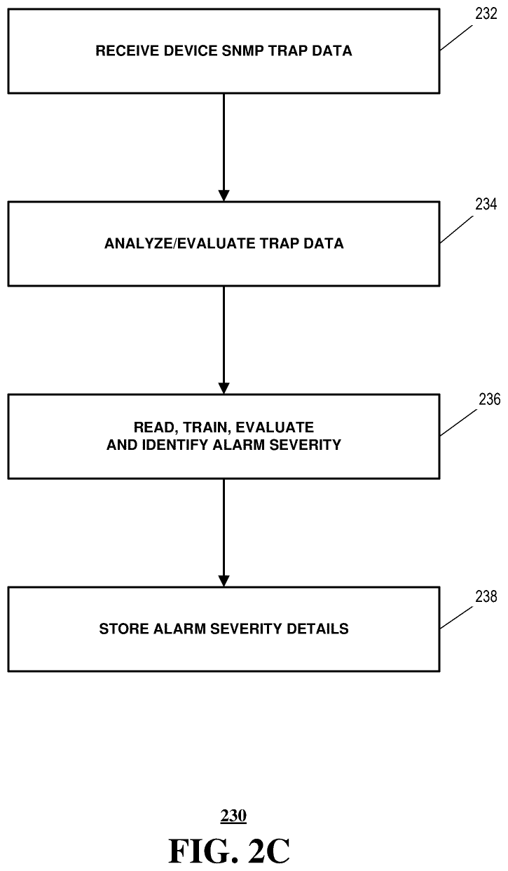

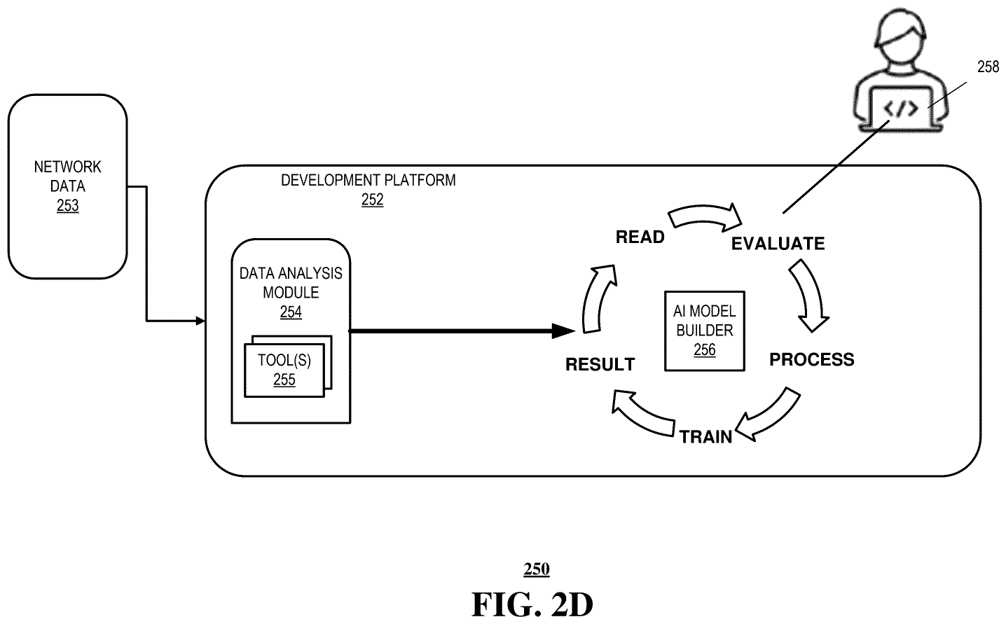

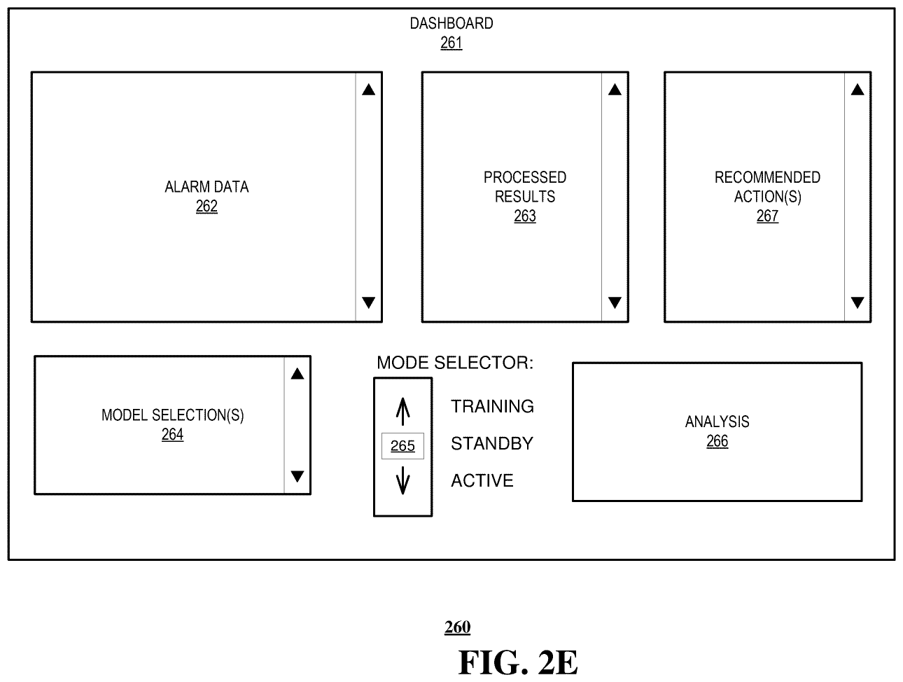

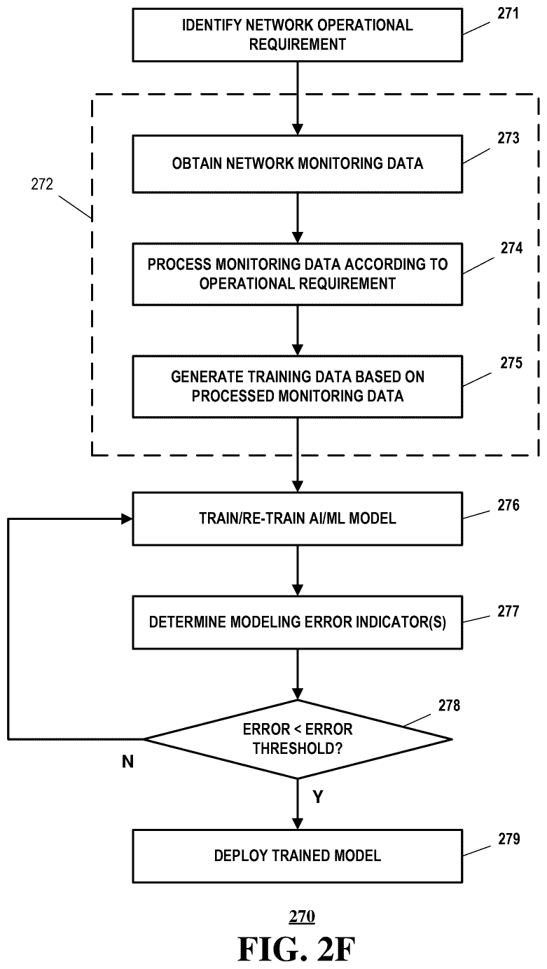

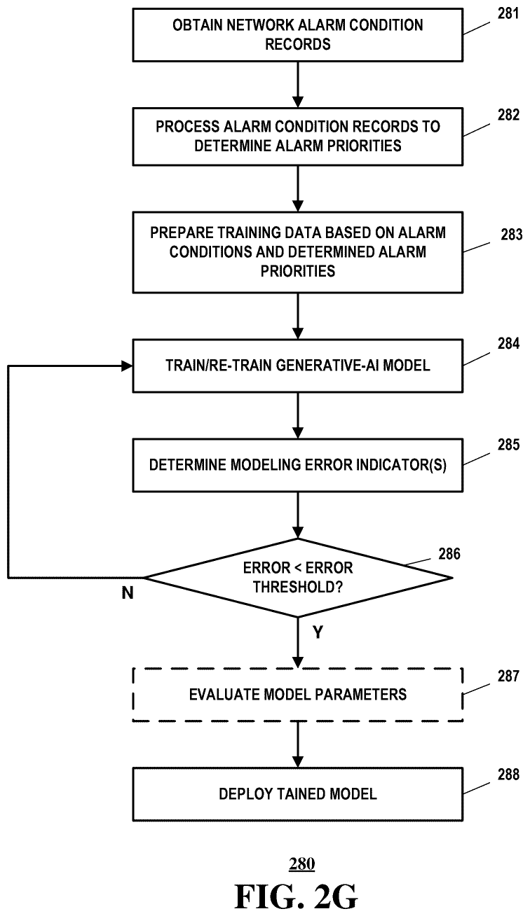

FIG. 2A is a block diagram illustrating an example, non-limiting embodiment of a network service assurance (NSA) predictive analysis system 200 functioning within the communication network 100 of FIG. 1 in accordance with various aspects described herein. The NSA predictive analysis system 200 includes a network monitor 202 configured to monitor a status and/or an activity of a network 204. The network 204 includes one or more network devices, sometimes referred to as network elements 206a, 206b, 206c, generally 206. In at least some embodiments, the network monitor 202 is configured to monitor network information including status and/or activities of at least some of the network elements 206.

In some embodiments, the network monitor 202 is configured to query or “ping” the monitored devices. The pings can occur at defined monitoring intervals, and if any device is down or if there is some other fault and/or alarm condition, the network monitor 202 can provide immediate notification by providing an indication of the alarm, e.g., an alarm signal, an alarm message, an email, a text message and so on. Alternatively, or in addition, one or more of the network 204, the network devices, and/or the network monitor 202, can initiate a reporting of network and/or device status information. In some embodiments, such status information can be generated and/or provided according to a monitoring and/or reporting schedule. Alternatively, or in addition, such status information can be generated responsive to an event and/or a condition. In at least some instances, the network elements 206 can utilize a protocol for monitoring and/or managing network and/or device information. By way of nonlimiting example, at least some of the network elements 206 can be configured to utilize the simple network management protocol (SNMP), which provides reporting messages referred to as “traps.”

The SNMP traps are adapted to provide notifications, e.g., messages from the network elements 206 directed to the network monitor 202. Beneficially, the SNMP traps can be used to report critical events and/or conditions in real time, and/or near real time. Without limitation, SNMP traps can be categorized generally into at least six categories: (i) cold start traps; (ii) warm start traps; (iii) link down traps; (iv) link up traps; (v) authentication failure traps; and (vi) exterior gateway protocol (EGP) neighbor loss traps. Cold start traps can indicate when a network element 206 has just been powered on, restarted or rebooted. Warm start traps can indicate when a network element 206 has just been restarted without losing its configuration. Link down traps can indicate when a network interface on a network element 206 has gone down. Link up traps can indicate when a network interface on a network element 206 has come up. Authentication failure traps can indicate when a user authentication attempt has failed, e.g., as an indication of a potential unauthorized attempt to access the network. EGP neighbor loss traps can indicate when a router loses an EGP routing protocol neighbor.

By way of further example, other protocol traps can be directed to: (i) CPU utilization traps; (ii) interface state change traps; (iii) memory utilization traps; and (iv) power supply failure traps. For example, CPU utilization traps can indicate when the processor or CPU utilization of a network element 206 exceeds a certain threshold. This can be an indicator of potential performance issues on the network element 206. For example, interface state change traps can indicate when the state of a network interface changes. This can be an indicator to detect potential network disruptions. For example, memory utilization traps can indicate when memory on the network element 206 falls below a certain threshold. For example, power supply failure traps can indicate when a power supply of the network element 206 fails.

In at least some embodiments, the network monitor 202 can operate at least in part, according to a protocol, such as the SNMP protocol. The network monitor 202 can receive trap messages from the network element 206 when specific events occur. In some embodiments, the network monitor 202 can be configured to process the received network notification messages, such as the example trap messages or alarms. Such processing can result in further actions, e.g., initiated by the network monitor 202. Such further actions, sometimes referred to as “tickets” can include, without limitation, providing notification, e.g., to network operators and/or administrators, logging the events and/or executing a predetermined network reporting and/or configuration action as can be accomplished by executing a code, e.g., a script.

In general, the network monitoring and/or reporting information, including the example trap message data can include and/or otherwise be associated with alarms. In at least some embodiments, the alarms correspond to one or more of the preceding trap message categories. It can be appreciated that not all alarms are equal. Namely, some alarms can have relatively high priority or criticality, e.g., requiring prompt or even immediate attention and/or enactment of specialized action(s). Other alarms can be of a lesser priority, e.g., being more informative. It is envisioned, however, that such lesser priority alarms may rise to higher priorities or criticalities when considered in relation to other network conditions and/or alarms, such as historical alarms of the same type and/or associated with the same network element 206 and/or conditions of other network elements 206 that together can be indicative of a higher priority condition. Accordingly, it is envisioned that one or more rules and/or algorithms can be utilized, e.g., by the network monitor 202, to evaluate and/or otherwise process received alarm data and/or by the various predictive models disclosed herein.

The network 204 can be configured to provide one or more network services, e.g., to one or various types of subscriber equipment 207. These services can be provided according to service level agreements (SLA) that establish at least a level of assurance that the services will be provided according to one or more metrics. For example, key performance indicators (KPIs) represent metrics chosen to gauge how well a service is provided against some agreed standards. It can be appreciated that at least some network monitoring and/or reporting information, e.g., SNMP trap messages and/or alarms can indicate the likelihood of a deleterious effect that can jeopardize and/or otherwise tarnish the KPIs, possibly breaching SLAs. It can also be appreciated that reacting to alarms, e.g., in the form of network operator tickets, results in a corresponding cost. Network operation and maintenance resources, e.g., personnel, equipment, processing resources, are limited. Accordingly, such resources should be employed in an efficient manner to maintain network operational performance without unnecessary expenditure. Accordingly, the various network monitoring information and/or reporting information e.g., the alarms, can be prioritized into at least two or more categories. For example, high priority alarms, i.e., Level-1 alarms can require that a network service action be taken as would be indicated by issuance of a ticket. Alternatively, lower priority alarms, such as a medium priority or Level-2 alarms can require that some information be taken note of or otherwise logged, without necessarily requiring any further action as might otherwise be associated with issuance of a ticket. Even lower priority alarms, e.g., Level-3 alarms can require little or no action, such that they can be essentially ignored in at least some instances.

Network monitoring, evaluation of alarms and response, as can be necessary to ensure network operations, can be referred to generally as operations (Ops) and/or network service assurance (NSA). An NSA infrastructure strives to deliver network services according to corresponding SLAs. NSA represents a mission critical infrastructure that supports the integrity, availability, and performance of telecommunications, broadband communications, mobile communications, network services, etc. NSA, however, comes at a very high cost for platforms that run many algorithms, rules, and processes to determine legitimate problems in the network. NSA and/or Ops can be implemented at least in part using automation in a user interface (UI) that can include dashboard-style UI for network elements to quickly determine network vulnerabilities, issues, and outages.

Network operators of large networks, e.g., enterprise networks, regional networks and/or national networks can find themselves monitoring extremely large numbers of network elements 206, e.g., numbering in the thousands, tens of thousands or even more devices. It has been observed that an associated alarm reporting, e.g., according to the SNMP traps, can be overwhelming due at in part to the sheer volume of alarms and in part to time sensitive nature of certain failures, which should be identified and responded to expeditiously to ensure that KPIs are minimally impacted, and that SLAs are maintained. In response, a network operator can employ rules, functions, and/or algorithms configured to process the high volumes of alarms and/or alarm messages and to prioritize them in an automated manner. To this end, the rules, functions and/or algorithms can be created using software, e.g., according to a software development life cycle (SDLC), e.g., being incorporated into and/or added onto the network monitor 202. Alternatively, or in addition, the rules, functions and/or algorithms can be implemented in another device, e.g., accessible via a user interface 214.

Unfortunately, this approach requires long, iterative and complex SDLC to design, develop and test rules, patterns, and event manipulation to determine measurements for network service assurance. Solutions according to the SDLC generally require a dedicated software development team to apply complex methodologies in developing specialized software. Such rigid code-based software development requires change request for any adjustments and takes too long and costly to develop, test and iterate.

The example NSA predictive analysis system 200 includes a predictive model, e.g., an NSA model 210, that can be configured to process network monitoring and evaluate and/or predict a severity of any alarm data. The NSA model 210 can be configured to efficiently and expeditiously process large volumes of such alarm data for large number of network elements 206, to obtain a prioritization of the alarms and in at least some instances, generation of a recommended responsive action to promote continued network operations according to a particular level of service quality, e.g., as can be determined according to one or more SLAs. For example, sample alarm data can be explored and modelled according to one or more parameters. A variable importance of the model's parameters can be determined, and the model can be analyzed for accuracy. Having been suitably prepared and/or otherwise initialized, a resulting model can be invoked, e.g., by the network monitor 202 and/or via the user interface 214 to process incoming, e.g., “live” alarms and to quickly prioritize and/or otherwise predict a criticality of the alarms.

In at least some embodiments, the NSA model 210 can include artificial intelligence (AI) and/or machine learning (ML). For example, an AI model, such as a neural network, can be prepared, e.g., according to suitable training data. In at least some embodiments, the training data can be retained in a training data repository 212 that is accessible to the NSA model 210. Suitable training data can include processed alarm data, e.g., alarm data that has been evaluated by some other means to determine prioritization and/or criticality. According to a training process, the NSA model 210 can be configured to receive the alarm data and to process the alarms to obtain a prioritization and/or some other measure of criticality, such as a grouping according to severity level, e.g., the example Level-1 to Level-3 and/or some other indication, such as a color coding, e.g., red, yellow, green, with red corresponding to critical alarms, yellow corresponding to less critical alarms and green corresponding to non-critical alarms. Model predictions can be compared with processed results to determine some measure of model error. The model error can be used to improve performance of the model, until the NSA model 210 is configured to provide predictions and/or criticalities within some tolerable error bound. The suitably trained NSA model 210 can then be applied to live alarms to automatically and quickly generate priorities and/or criticalities.

Operation of the network 204 can include, without limitation, voice communications, data communications, and combinations thereof, which can include point-to-point communications, point-to-multipoint communications, e.g., multicast communications, and/or broadcast communications. Communications supported by the network 204 can include an exchange of information, e.g., voice and/or data network messages or packets between, subscriber equipment 207 and/or network terminal devices or endpoints, e.g., network elements 206 operating at an edge of the network 204. The exchanges of network messages can be facilitated by one or more network paths supported by a group of the network elements 206.

In at least some embodiments, the NSA predictive analysis system 200 includes at least one information repository 208. The information repository can include a database, such as a management information database, a report, e.g., a textual document, a spreadsheet, an XML file, and the like. By way of example, the information repository 208 can store information related to one or more of a configuration of the network elements 206, status of the network elements, one or more performance indicators related to the network elements 206, e.g., memory usage, CPU usage, power consumption, available stored power, expansion capacity, device generated alarms, and the like, referred to herein as network element data. Alternatively, or in addition, the information repository 208 can store information related to a network topology, e.g., identification of network neighbors and/or interconnections among the network elements 206, network outage data, network alarm data, e.g., communication links and/or network segments, referred to herein as network data. It is envisioned that the information repository can store and/or otherwise retain current information and in at least some instances, historical information. For example, the stored network element and/or network information can be representative of instantaneous conditions. Alternatively, or in addition, the stored network element and/or network information can be representative of most recently sampled configurations and/or conditions. In at least some embodiments, the stored network element and/or network information can be representative of data collected over a time period, e.g., a monitoring period, observation period and/or sample period as can be determined over some number of seconds, minutes, hours, days, weeks, etc. In such instances, the stored network element and/or network information can store maximum values, minimum values and/or averaged values over the monitoring periods.

In at least some embodiments, the NSA predictive analysis system 200 includes a network management function configured to configure and/or modify a configuration of a least a portion of the network 204. For example, the network monitor 202 can be part of a network management system that is configured to perform both network configuration and network monitoring functions. Configurations and/or modifications of the network elements 206 can include, without limitation, incorporation of a network element 206 into a network topology, activation of a network element 206. Alternatively, or in addition, configuration of a network element 206 can include version updates, power settings, storage capacity and/or allocation, processing. A network topology can include identities of the network elements 206, e.g., a network address, a device identifier, neighboring devices, interconnected devices, and so on.

Monitoring of the network, including monitoring of at least some of the network elements 206 can include monitoring network activity, device activity, e.g., power consumption, power storage capacity, power failure, memory usage, processor usage, thermal loads, diagnostic test results, fault status, failover status, spare status, and/or general health or status of network elements 206. In at least some embodiments, monitoring of the network includes identification of an existing network topology including at least some of the network elements 206, a configuration and/or reconfiguration of at least some of a network topology, e.g., network neighbors, and/or configurations of one or more of the network elements 206, e.g., port assignments, version status of device software and/or firmware, device type, vendor, physical location owner and/or operator.

It is understood that in at least some embodiments, at least some of the network elements 206 can operate collectively in provisioning and/or delivery of the network services. Example networks 204 can include, without limitation, terrestrial networks, including, e.g., wired and/or cabled networks, optical networks, wireless networks, e.g., radio networks, microwave networks, and so on. Other example networks 204 include satellite networks and/or wireless mobile networks. The networks 204 can any combination of point-to-point networks, personal area networks, local area networks (LAN), enterprise networks, metropolitan networks, wide area networks, e.g., the Internet, mesh networks, private networks, public networks, and so on. By way of example, network devices can include any equipment that contributes to network communications, such as routers, switches, servers, gateways, transmitters, receivers, modems, multiplexers, mobile base stations, mobile access points, repeaters, firewalls, load balancers, wireless LAN controllers, servers, virtual machines (VMs), printers, storage devices, communication links, and the like.

FIG. 2B is a block diagram illustrating an example, non-limiting embodiment of another NSA predictive analysis system 220 functioning within the communication network of FIG. 1 in accordance with various aspects described herein. The example NSA predictive analysis system 220 includes a network monitor 221 configured to monitor operation and/or configuration of a network 222. In at least some embodiments, the network monitor 221 can operate according to a network protocol, e.g., SNMP.

Further according to the illustrative example, the NSA predictive analysis system 220 includes a data receiver 223 in communication with the network monitor 221 and/or equipment of the network 222. In at least some embodiments, the data receiver 223 can be configured to preprocess network monitoring and/or configuration data, e.g., categorizing the data, sorting the data, parsing the data, translating the data, and so on as can facilitate further processing by the NSA predictive analysis system 220.

According to the illustrative example, the data receiver 223 is in further communication with a data explorer 224. The data explorer 224 can receive preprocessed data obtained from the data receiver 223 and/or via the network monitor 221. The data explorer 224 can include one or more rules, functions and/or algorithms to explore the received network monitoring and/or configuration data. For example, exploration of received data in the form of alarms regarding devices of the network 222 can be configured to identify certain types of alarms and/or certain alarm values considered alone, or in combination and in at least some embodiments, in combination with network configuration data. In at least some embodiments, the data explorer 224 explores alarm data according to predetermined alarm thresholds and/or ranges, e.g., introducing indications of the exploration. Indications can include associations of exploration values, e.g., categories, ranges, values, and so on, with the received data, e.g., with the alarms.

In at least some embodiments, the NSA predictive analysis system 220 includes a data preparer 225. The example data preparer 225 is in communication with at least the data explorer 224. The data explorer 224 is configured to receive pared data, which can include one or more of prepared network monitoring data, prepared network configuration, prepared network device alarm data and/or any other indications regarding the same as can have been added by the data explorer 224. In at least some embodiments, the data preparer 225 facilitates a processing of received data, e.g., the alarms, to obtain a suitable training data set containing network monitoring, configuration and/or alarm data and corresponding prioritization and/or criticality values.

In some embodiments, one or more of the data exploration performed by the data explorer 224 or the data preparation performed by the data preparer can be automated, e.g., implementing rules, algorithms and/or applications configured to perform the data exploration and/or data preparation. Alternatively, or in addition, at least some of the data exploration or data preparation can be performed, at least in part, under a manual process. For example, the NSA predictive analysis system 220 can include a user interface 229 to facilitate manual interaction with one or more components, devices and/or subsystems of the NSA predictive analysis system 220, e.g., in support of data exploration and/or data preparation.

According to the illustrative example, the NSA predictive analysis system 220 can include a model trainer 226. The model trainer 226 can be configured to facilitate training of a model, such as the example predictive model 228. It is understood that in at least some embodiments, the predictive model 228 can include an AI and/or ML model. It is envisioned that such model training can be accomplished, at least in part, according to prepared data obtained from the data preparer 225. The model trainer 226 can provide the prepared training data to the predictive model 228 according to a training process in which model predictions can be obtained and compared to known results to obtain a measure of error in the predictions.

According to the illustrative example, the NSA predictive analysis system 220 includes a trained model evaluator 227. The trained model evaluator 227 can be configured to receive information from the model trainer 226. In at least some embodiments, this information can include model results obtained from training data inputs. These results can be compared with predetermined results to obtain a measure of the model prediction error, e.g., a difference between prepared results and modeled results. Any such error measurement can be evaluated by the trained model evaluator 227 to determine one or more adjustments to one or more parameters of the model. In at least some embodiments, the evaluations can be determined automatically, e.g., according to evaluation rules, algorithms and/or applications. Alternatively, or in addition, the evaluations can be determined manually, such that an adjusted model can be obtained in either instance. The same and/or different prepared training data can be reapplied to the model, e.g., by the model trainer 226 to obtain updated and/or otherwise refined model results that are further evaluated by the trained model evaluator 227 and the process can be repeated until some satisfactory model performance is obtained. In at least some embodiments, satisfactory results can be determined when an error between predicted and expected results falls within some error threshold. Upon such a determination, the model can be declared as a suitably trained predictive model 228.

Having established a suitably trained predictive model 228, the trained predictive model 228 can be applied to current or live network monitoring, configuration and/or alarm data as can be received via the network monitor 221. The model can provide predictions which can be provided to one or more of the user interface 229 and/or the trained model evaluator 227. For example, the trained model evaluator 227 can be configured to monitor the operation of the trained predictive model 228. In at least some embodiments, the trained model evaluator can receive predicted severity and/or predictive reactions to alarm data. The predictions can be compared with actual results, e.g., actions taken, which can be determined to be correct, e.g., upon manual inspection and/or further analysis and/or test. To the extent that the predictions are determined to be inaccurate, the trained model evaluator can identify and/or otherwise initiate further adjustments to the trained model based upon the model's predictions made to the live data, to obtain an ongoing training.

FIG. 2C depicts an illustrative embodiment of a network service assurance (NSA) predictive analysis process 230 in accordance with various aspects described herein. According to the example NSA predictive analysis process 230, network information is received at 232. The received information can include configuration information related to the device, e.g., a configuration of hardware, software, firmware, portion configurations, network interconnections, performance indicators and/or information regarding errors and/or failures related to the device. In at least some embodiments, the received information can subscribe to a protocol, such as SNMP. For example, SNMP trap messages can be generated responsive to a condition of a network and/or a network device or element. The SNMP trap messages can include information identifying a network a device, a configuration of a network and/or a configuration of the device, an error condition and/or a fault.

The network information can be analyzed and/or evaluated at 234. For example, SNMP trap messages regarding faults and/or error conditions can be analyzed. In at least some embodiments, the analysis can associate a priority value to received SNMP trap messages. The priority can relate to a criticality of the received SNMP trap messages. For example, some SNMP errors can indicate a failure of a device, a device feature, a link, and the like. To the extent that the failure relates to a service being monitored under an SLA function, the analysis and/or evaluation can determine a criticality according to an impact that the failure can have to an SLA objective, e.g., to KPIs and/or service level agreements, associated subscribers, associated revenue, associated service and/or subscriber and/or data priority, and the like. Accordingly, the failure can be categorized and/or otherwise ranked according to the associated and/or otherwise estimated criticality. It is understood that such estimates of priorities and/or criticalities can be predictive, e.g., having an associated likelihood of impacting the SLA objective and/or an anticipated severity should the SLA objective be impacted.

In at least some embodiments, the alarm severity can be used to train a predictive model at 236. It is envisioned that alarm data, e.g., SNMP trap messages can be collected for a network over some period of time in which the collected data captures various events, failures and so on. In at least some embodiments, the collected data can be compared with historical records of actual impacts and/or severity to one or more SLA objectives, as can have been obtained with legacy systems. Together, the monitored network data, e.g., SNMP trap alarms and consequences can be used as training data. For example, the SNMP trap alarm data can be input into a predictive network alarm evaluation model. The model can be configured to predict an impact, severity and/or resolution given the example alarm data. The model predictions can be compared to, so called, actual data to determine whether the model was accurate. In at least some embodiments, an error can be determined as a difference between predictions and actual results. The error can be used to adjust one or more model features according to a training process in which the error can be reduced in subsequently trained versions of the model.

According to the illustrative NSA predictive process 230, and in at least some embodiments, the alarm severity data can be stored at 238. For example, a suitably trained model can be used to process new network data, e.g., new alarms, which in at least some embodiments, can be processed in real time and/or in near real time. The predicted results can be used to determine whether a network response is necessary and in at least some embodiments, identify a type of response and/or a specific response, e.g., reboot a device associated with the failure, replace the device associated with the failure, re-route network traffic, and so on. Such stored alarm severity data can be evaluated to extend and/or otherwise enhance training data. For example, a new type of network, a new network protocol, a new device, or a previously unobserved condition, e.g., alarm, can be observed and added to the training data to improve, extend and/or otherwise enhance performance of the model for future applications.

FIG. 2D is a block diagram illustrating an example, non-limiting embodiment of a network service assurance (NSA) predictive analysis development platform 250 functioning within the communication network of FIG. 1 in accordance with various aspects described herein. The example NSA predictive analysis platform 250 includes a development platform 252 configured with one or more data analysis modules 254 and a model development module 256. The NSA predictive analysis platform 250 is configured to receive information from an information source, e.g., in the form of network data source 253. According to the illustrative examples provided herein, the received information can include network information, such as network configuration information, network operations information, e.g., including network state information, network equipment information, network equipment operations information, e.g., including network equipment stat information, and the like.

In at least some embodiments, the network data source 253 can include a network monitor, such as the example network monitors 202 (FIG. 2A), 221 (FIG. 2B). Alternatively, or in addition, the network data source 253 can include a network information repository, such as the example information repository 208 (FIG. 2A), sometimes referred to as a management information base (MIB), which can include a database used for managing a network, a network segment and/or network elements 206 (FIG. 2A). The network data source 253 can be configured to contain monitoring information for a network and/or a network element, which can include status and/or performance information as can be obtained and/or otherwise updated to facilitate monitoring activity. Alternatively, or in addition, the network data source 253 can include detailed information about each network element, such as a make, model, version, configuration, historical performance information and/or indicators, and the like. Other network data provided by the network data source 253 can include information related to usage and/or trends in usage and/or performance. Still other network data can include network configuration data, e.g., network information, network segment information, network configuration information, network neighbors, and so on.

The data analysis module(s) 254 can provide one or more data analysis tools 255, e.g., in the form of functions and/or applications configured to facilitate manipulation of information, such as the example network data received from the network data source 253. Without limitation, such data analysis tools 255 can include data interpretation tools, e.g., providing data conversions and/or format conversions as can facilitate interpretation by a user and/or further processed, e.g., by the model development module 256. Alternatively, or in addition, the data analysis tools 255 can include one or more data filters. For example, data filters can be established in the data analysis module 254 to selectively process data based on one or more data filters. These filters can take any form as can be beneficial for facilitating, e.g., expediting, further processing. Filters can be established to pass and/or block certain types of network information, e.g., pass network element alarms, but block network traffic information. Alternatively, or in addition, the filters can be configured according to one or more thresholds and/or bounds, e.g., selectively blocking and/or passing alarm information of a particular device type, of a particular geographic region, of a particular network and/or network segment, of a particular alarm category or type, and so on.

In at least some embodiments, the data analysis module(s) 254 can include other data analysis tools 255 as can be used to facilitate further interpretation by a user and/or further processed, e.g., by the model development module 256. For example, the data analysis tools 255 can include a scripting tool configured to facilitate development and/or implementation of executable code and/or scripts as can be used to process network data received from the network data source 253. Alternatively, or in addition, the data analysis tools 255 can include data evaluation tools, e.g., performing functions, such as statistical functions, e.g., summing, averaging, bounding functions, e.g., max and/or min functions, comparison functions, generating time series, presentation functions, e.g., facilitating data visualization, generation of graphs and so on.

The model development module 256 can be configured to read data, e.g., model input data, to evaluate data, e.g., to obtain model features and/or model predictions and/or model output. Alternatively, or in addition, the model development module 256 can be configured to train a model, to process data, e.g., by applying data to a model, and in at least some embodiments, to generate, prepare and/or otherwise provide results, e.g., model output. In at least some embodiments, the development platform 250 can include a user interface 258.

In at least some embodiments, the development platform 252 incorporates automation tools, such as machine learning automation tools. Such tools are configured to empower data scientists to work on projects faster and more efficiently by using automation to accomplish key machine learning tasks in just minutes or hours, not months. At least some of the automation tools can deliver one or more of automatic feature engineering, model validation, model tuning, model selection and/or deployment, machine learning interpretability, bring your own recipe, time-series, and automatic pipeline generation for model scoring, etc. By way of example, the automation tool can include H2O Driverless AI® computer software platform available from H2O.AI®, Inc. of DE. In at least some embodiments, the automation tools can provide network operators with an extensible customizable data science platform that addresses the needs of a variety of use cases for every enterprise in every industry. For example, the data analysis module may include tools for creating and/or sharing computational documents, such as the Jupyter® web-based interactive computing platform, available from NumFOCUS®, Inc. of TX.

FIG. 2E is a block diagram illustrating an example, non-limiting embodiment of a user interface 260 configured for network service assurance (NSA) predictive analysis functioning within the communication network 100 of FIG. 1 in accordance with various aspects described herein. The example user interface can include a dashboard 261 configured to arrange one or more groups of information. The arranged groups of information can be relevant to one or more of network monitoring, network monitoring model development and/or evaluation, and/or network monitoring according to a suitably trained model, e.g., a predictive NSA severity model.

According to the illustrative example, the dashboard 261 includes a first information group related to network monitoring data, e.g., a network alarm information group 262. The network alarm information group 262 can be configured to display previously obtained network alarm data as can be used in a model development and/or model evaluation process. For example, the network alarm information group 262 can present a stored collection of network alarms obtained for a particular network, network segment and/or device. The stored collection of network alarms can be evaluated, e.g., manually by an operator interacting with the dashboard 261 to associate a network issue, an alarm priority, an alarm criticality and/or a resolution as can relate to an NSA objective. Alternatively, or in addition, the network alarm information group 262 can present recent or current network alarms as can have been obtained in real time and/or near real time.

In at least some embodiments, the current network alarms can be evaluated according to one or more of the various automated techniques disclosed herein. For example, a predictive NSA severity model can be applied to the current data with an objective of identifying critical alarms and in at least some embodiments, for also identifying one or more recommended responsive actions. In at least some embodiments, recommended responsive actions can be corrective in nature, e.g., designed to address an error condition such that the error condition can be resolved. Alternatively, or in addition, recommended responsive actions can be preservative in nature, e.g., taking action to mitigate other related issues as can result from a fault.

In at least some embodiments, the example dashboard 261 can include a processed results information group 263. The processed results information group 263 can include information related to predictions associated with alarms presented in the network alarm information group 262. The processed results information can relate to previously determined processed results as may be used during model development, e.g., model training. Alternatively, or in addition, the processed results information group can relate to severity values, e.g., associated with alarms presented in the network alarm information group 262. It is envisioned that presented information may include textual information, color-coded information, graphical information, video information, and the like. For example, severity values may be distinguished according to a label, e.g., Level_1 severity indicating a highest severity level, Level_2 severity indicating an intermediate severity level, and Level_3 severity indicating a lowest severity level. Alternatively, or in addition, the severities can be indicated with a color coding, e.g., “Red” for Level_1 severity, “Yellow” for Level_2 severity, and “Green” for Level 3 severity. Although the illustrative examples refer to three distinguishable levels, it is understood that in other embodiments, greater and/or fewer distinguishable levels of layers may be used.

In at least some embodiments, the example dashboard 261 can include a recommended actions information group 263. The recommended actions can be associated with an alarm presented in the network alarm information group 262 and/or the processed results, e.g., a severity associated with the alarm, as can be presented in the recommended actions information group 263. The recommended actions may be presented as textual information, which may be descriptive, encoded and/or some combination of description and encoding. The recommended actions can include any of the various examples disclosed herein and/or otherwise known to those familiar with network operations and monitoring, and/or with NSA objectives. In at least some embodiments, recommended actions presented in the recommended actions information group 267 are directed toward removing the alarm condition. Alternatively, or in addition, the recommended actions are directed toward preventing an escalation of a severity associated with the alarm condition.

The dashboard 261 can include other information groups, such as the model selection(s) information group 264, which can be adapted to display a selection of models. It is envisioned that some models may be directed towards particular networks, particular types of network equipment, particular alarms, particular NSA objectives, particular network operational conditions, e.g., stressed vs non-stressed, busy hour vs. non-busy hour, and so on. It is envisioned further that the dashboard 261, in addition to presenting information for display, may accept user inputs, such as selection from among a group of available models.

The example dashboard 261 includes a mode selector 265. For example, the mode selector may be manipulated by a user to select whether a model selected via the model selection(s) information group 264 is used in a training mode, an active mode and, in at least some instances, in a standby or bypass mode. Examples of other information groups can include, without limitation a data visualization and/or analysis information group 266. In at least some embodiments, the analysis information group 266 can present a data visualization and/or data manipulation environment and/or app that can allow a user to explore related information, such as alarm data, network configuration data, stored records, currently obtained data, SNMP trap messages, and so on. In at least some embodiments, the analysis information group 266 may present features controlled by one or more application programs or apps. At least one such example app allows a user to create executable code, e.g., scripts, to explore and/or otherwise analyze data, to communicate, to access data, and the like.

FIG. 2F depicts an illustrative embodiment of a network service assurance (NSA) predictive analysis process 270 in accordance with various aspects described herein. According to the example NSA predictive analysis process 270, an operational requirement of a network is identified at 271. In at least some embodiments, the operational requirement relates to an NSA objective. In at least some embodiments, the example NSA predictive analysis process 270 can generate model training data at 272. According to the illustrative example, generation of the model training data can include one or more of obtaining network monitoring data at 273, processing monitoring data at 274 according to the identified operational requirement to obtain processed monitoring data and generating training data at 275 based on the processed monitoring data.

Further according to the example NSA predictive analysis process 270, a model, such as an AI and/or a ML model can be trained and/or re-trained at 276. According to a training process, modeled results may be compared at 277 with training data generated at 272. In at least some embodiments, an error indicator can be determined based on the comparison. The error value can be compared to a threshold error value at 278. For example, it is understood that there is some value of error that is small enough, i.e., below the threshold, such that the trained model may be validated and/or otherwise identified as being suitable for deployment. To the extent it is determined at 278 that the error exceeds the error threshold, the process continues to train and/or retrain the model at 276, determine an updated modeling error indicator at 277 and again comparing the updated modeling error to the threshold at 278. To the extent it is determined at 278 that the error falls below the error threshold, the NSA predictive analysis process 270 proceeds to identify the model as suitable for deployment and/or actually deploying the model at 279. It is envisioned that the example NSA predictive analysis process 270 may be repeated as necessary based on performance indicators of a deployed model and/or identification of a new and/or modified network operational requirement, a network reconfiguration, deployment of a new network, new network devices or elements and so on.

FIG. 2G depicts an illustrative embodiment of a network service assurance (NSA) predictive analysis process 280 in accordance with various aspects described herein. According to the example predictive analysis process 280, network monitoring information, e.g., network alarm condition records are obtained at 281. In at least some embodiments, the network alarm condition records can be processed at 282. For example, the network alarm condition records may represent historical records obtained for the network being monitored and/or some other network that may or may not be similar. Without limitation, the processing of the network alarm conditions can be configured to identify priority value of an alarm, a severity value of an alarm, and/or a recommended action in response to the alarm.

According to the illustrative embodiments, the predictive analysis process 280 can prepare training data at 282 based on the alarm, related alarm conditions and/or alarm priority values, severity values and/or recommended actions as may have been determined at 281. Having prepared the training data, a model, e.g., an AI model, which in at least some embodiments may include a generative AI model, can be trained at 284 according to the prepared training data.

Further according to the example NSA predictive analysis process 280, a model, such as the trained example generative AI model can provide modeled results that can be compared at 285 with training data generated at 283. In at least some embodiments, an error indicator can be determined at 285 based on the comparison. The error indicator or value can be compared to a threshold error value at 286. For example, it is understood that there is some value of error that is small enough, i.e., below the threshold, such that the trained AI generative model may be validated and/or otherwise identified as being suitable for deployment. To the extent it is determined at 286 that the error exceeds the error threshold, the process 280 continues to train and/or retrain the generative AI model at 284, determine an updated modeling error indicator at 285 and again comparing the updated modeling error to the threshold at 286. To the extent it is determined at 286 that the error falls below the error threshold, the NSA predictive analysis process 280 proceeds to identify the trained generative AI model as suitable for deployment and/or actually deploying the model at 288.

In at least some embodiments and according to the example NSA predictive analysis process 280, the model parameters may be evaluated at 287 (shown in phantom). In particular, the model parameters can be evaluated after it has been determined at 286 that the model is sufficiently trained. According to a generative AI process, the model parameters may be ill defined and/or left undefined at an outset of the training process. The generative AI modeling and/or model training process may provide insight, e.g., by way of the model parameters, which may prove valuable to further improvements of the generative AI-model and/or transferrable to other models and/or other applications.

It is worth noting here that many of the illustrative examples relate to NSA predictive analysis of a network. It is appreciated, however, that the devices, systems, techniques and/or software disclosed herein may be applied to other applications, such as network operations, network provisioning, e.g., including technical aspects, business aspects and/or financial aspects of such network activities. It is understood that in at least some embodiments, one or more of the techniques disclosed herein may be employed beyond network applications, e.g., in other fields, such as, without restriction, manufacturing, supply chains, financial services, digital retail, e.g., Amazon® e-commerce services, entertainment, online and/or computer gaming, social media, e.g., Meta® online social networking, health and/or medical services, educational services, and so on.

While for purposes of simplicity of explanation, the respective processes are shown and described as a series of blocks in FIGS. 2C, 2E and 2F, it is to be understood and appreciated that the claimed subject matter is not limited by the order of the blocks, as some blocks can occur in different orders and/or concurrently with other blocks from what is depicted and described herein. Moreover, not all illustrated blocks can be required to implement the methods described herein.

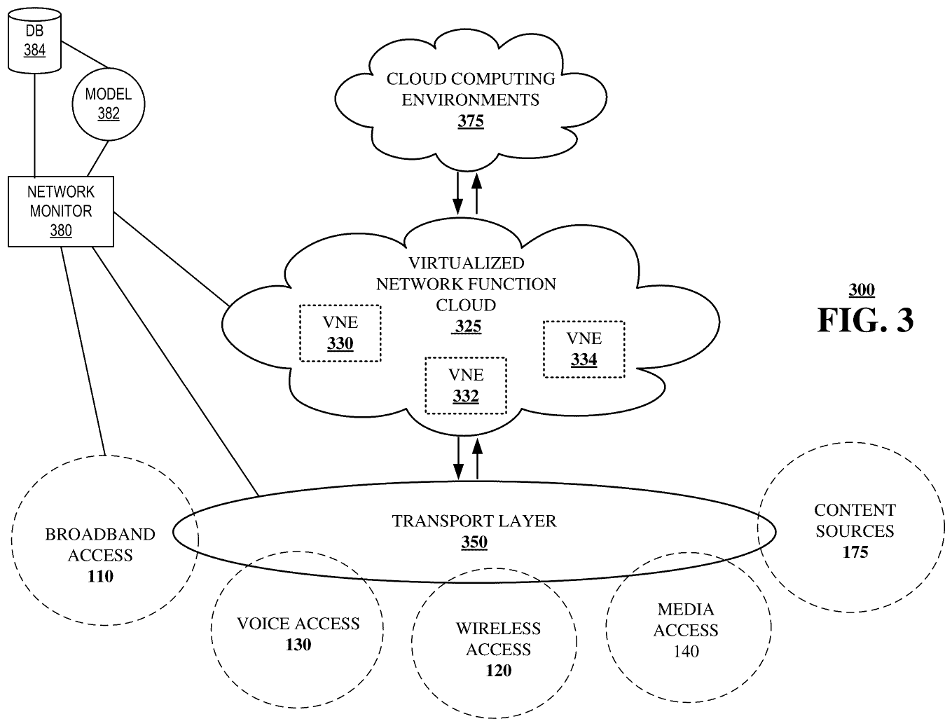

Referring now to FIG. 3, a block diagram is shown illustrating an example, non-limiting embodiment of a virtualized communication network 300 in accordance with various aspects described herein. In particular a virtualized communication network is presented that can be used to implement some or all of the subsystems and functions of the communications network 100, the subsystems and functions of the network service assurance predictive analysis system 200, 220, 250, the user interface 260 configured for network service assurance predictive analysis and the network service assurance predictive analysis processes 230, 270 and 280 presented in FIGS. 1, 2A, 2B, 2C, 2D, 2E, 2F, 2G and 3. For example, virtualized communication network 300 can facilitate in whole or in part identifying a network service assurance objective and obtaining first network monitoring data indicative of a first operational status of a group of network devices. The first network monitoring data can be prioritized according to the network operations objective to obtain first prioritized results and a predictive model can be trained based on the first network monitoring data and the first prioritized results. The second monitoring data indicative of a second operational status of the group of network devices are evaluated according to the trained predictive model to obtain second prioritized results, wherein the network monitoring data is prioritized according to the second prioritized results. The prioritized results can be obtained quickly and automatically and used to determine any responsive actions as can be necessary to address critical network issues related to the second monitoring data, without having to manually distinguish criticality.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc., that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc., to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc., can be instantiated and managed using an orchestration approach similar to those used in cloud compute services.

The cloud computing environments 375 can interface with the virtualized network function cloud 325 via APIs that expose functional capabilities of the VNEs 330, 332, 334, etc., to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

The example virtualized communication network 300 includes a network monitor 380, a network alert processing model 382 and an example network data repository 384. The network monitor 380 is in communication with the one or more of the virtualized network function cloud 325, the broadband access network 110, the wireless access network 120, the voice access network 130 and the media access network 140. The network monitor 380 can be configured to receive network monitoring information, such as messages, e.g., alarms, reported by one or more devices or elements of the monitored networks. It is understood that in at least some embodiments, the number of network elements and alarms related thereto can be enormous. It is understood that at least some monitored alarms can require a responsive action to ensure service level assurance (SLA) objectives. Beneficially, the network alert processing model 382 can be configured and/or otherwise trained to process alerts to obtain a prioritization and/or identification of those alerts and/or classes of alerts likely to impact the SLA objectives. Accordingly, a network operator can process excessively large numbers of alerts in order to quickly and in at least some embodiments, automatically, identify a subset of the alarms deemed to be critical, e.g., requiring attention and/or a response. The network data repository 384 can include information in support of such monitoring and analysis, e.g., including one or more of network configuration data, network device or element data, alarm criticality information, historical records of observed alarms and/or reactions thereto, and/or training data as can be beneficially for training the network alert processing model 382, e.g., when it utilizes artificial intelligence (AI) and/or machine learning (ML). It is understood that one or more of the network monitor 380, the network alert processing model 382 and/or the network data repository 384 can be implemented in part and/or in whole by virtual machines as can be hosted in the example cloud computing environments 375.

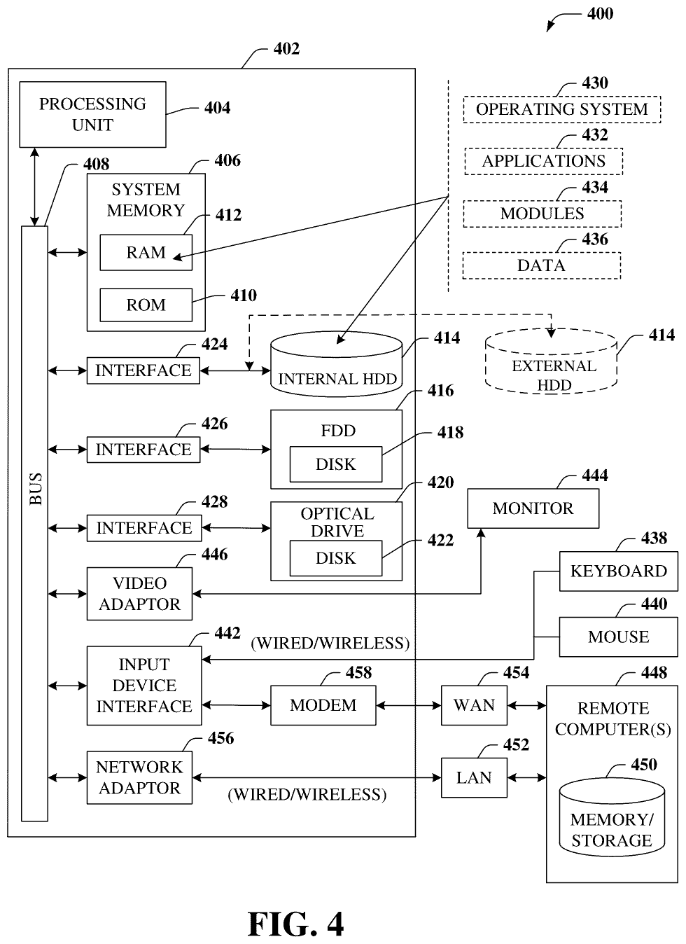

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part identifying a network service assurance objective and obtaining first network monitoring data indicative of a first operational status of a group of network devices. The first network monitoring data can be prioritized according to the network operations objective to obtain first prioritized results and a predictive model can be trained based on the first network monitoring data and the first prioritized results. The second monitoring data indicative of a second operational status of the group of network devices are evaluated according to the trained predictive model to obtain second prioritized results, wherein the network monitoring data is prioritized according to the second prioritized results. The prioritized results can be obtained quickly and automatically and used to determine any responsive actions as can be necessary to address critical network issues related to the second monitoring data, without having to manually distinguish criticality.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

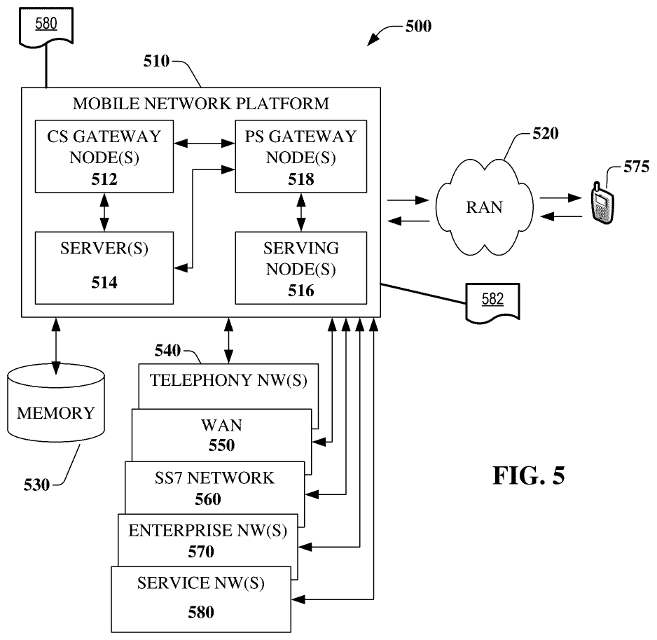

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part identifying a network service assurance objective and obtaining first network monitoring data indicative of a first operational status of a group of network devices. The first network monitoring data can be prioritized according to the network operations objective to obtain first prioritized results and a predictive model can be trained based on the first network monitoring data and the first prioritized results. The second monitoring data indicative of a second operational status of the group of network devices are evaluated according to the trained predictive model to obtain second prioritized results, wherein the network monitoring data is prioritized according to the second prioritized results. The prioritized results can be obtained quickly and automatically and used to determine any responsive actions as can be necessary to address critical network issues related to the second monitoring data, without having to manually distinguish criticality. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc., that perform particular tasks and/or implement particular abstract data types.

The example mobile network platform 510 includes a network monitoring function 580 and/or a network alert modeling function 582. The network monitoring function 580 can be configured to receive network monitoring information, such as messages, e.g., alarms, reported by one or more devices or elements of the monitored networks. In at least some embodiments, the network alert modelling function 582 can be configured and/or otherwise trained to process alerts to obtain a prioritization and/or identification of those alerts and/or classes of alerts likely to impact the SLA objectives. The network alert modeling function 582 can include aspects of artificial intelligence (AI) and/or machine learning (ML).

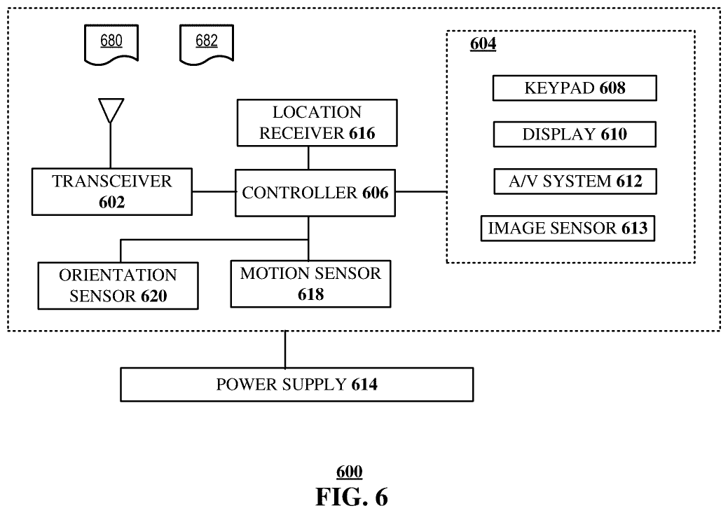

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part identifying a network service assurance objective and obtaining first network monitoring data indicative of a first operational status of a group of network devices. The first network monitoring data can be prioritized according to the network operations objective to obtain first prioritized results and a predictive model can be trained based on the first network monitoring data and the first prioritized results. The second monitoring data indicative of a second operational status of the group of network devices are evaluated according to the trained predictive model to obtain second prioritized results, wherein the network monitoring data is prioritized according to the second prioritized results. The prioritized results can be obtained quickly and automatically and used to determine any responsive actions as can be necessary to address critical network issues related to the second monitoring data, without having to manually distinguish criticality.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human car) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The example communication device 600 includes a network monitoring function 680 and/or a network alert modeling function 682. The network monitoring function 680 can be configured to receive network monitoring information, such as messages, e.g., alarms, reported by one or more devices or elements of the monitored networks. In at least some embodiments, the network alert modelling function 682 can be configured and/or otherwise trained to process alerts to obtain a prioritization and/or identification of those alerts and/or classes of alerts likely to impact the SLA objectives. The network alert modeling function 682 can include aspects of artificial intelligence (AI) and/or machine learning (ML).

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
determining a network service assurance (NSA) objective;
receiving first network monitoring data indicative of a first operational status of a plurality of network devices;
processing the first network monitoring data according to the NSA objective to obtain a plurality of first processed results;
training a model based on the first network monitoring data and the plurality of the first processed results to obtain a trained model;
processing, according to the trained model, second network monitoring data indicative of a second operational status of the plurality of network devices to obtain a plurality of second processed results; and
prioritizing the second network monitoring data according to the plurality of the second processed results.

2. The device of claim 1, wherein the first network monitoring data comprises a first plurality of network alarms.

3. The device of claim 2, wherein the processing the first network monitoring data further comprises:
associating a severity with each alarm of the first plurality of network alarms.

4. The device of claim 1, wherein each second processed result of the plurality of the second processed results is associated with a network response activity of a plurality of network response activities to obtain a plurality of associations, and wherein the prioritizing the second network monitoring data is based on the plurality of associations.

5. The device of claim 1, wherein the receiving the first network monitoring data further comprises:
receiving messages determined according to a network monitoring protocol.

6. The device of claim 5, wherein the network monitoring protocol comprises a simple network monitoring protocol (SNMP).

7. The device of claim 1, wherein the model comprises one of a machine learning model or artificial intelligence (AI) model.

8. The device of claim 7, wherein the AI model comprises a neural network.

9. The device of claim 1, wherein the model comprises generative artificial intelligence.

10. The device of claim 1, wherein the training the model comprises unsupervised learning.

11. The device of claim 1, wherein the training the model further comprises:
automatically recognizing features to obtain recognized features, wherein the recognized features expedite the training of the model.

12. A method, comprising:
determining, by a processing system including a processor, a network operations objective;
receiving, by the processing system, first network monitoring data indicative of a first operational status of a plurality of network devices;
evaluating, by the processing system, the first network monitoring data according to the network operations objective to obtain a plurality of first prioritized results;
training, by the processing system, a predictive model based on the first network monitoring data and the plurality of first prioritized results to obtain a trained predictive model; and
processing, by the processing system and according to the trained predictive model, second monitoring data indicative of a second operational status of the plurality of network devices to obtain a plurality of second prioritized results, wherein the network monitoring data is prioritized according to the plurality of second prioritized results.

13. The method of claim 12, wherein the receiving, by the processing system, the first network monitoring data further comprises:
receiving, by the processing system, messages determined according to a network monitoring protocol.

14. The method of claim 12, wherein the predictive model comprises one of a machine learning model or artificial intelligence (AI) model.

15. The method of claim 12, wherein the training the predictive model comprises unsupervised learning.

16. The method of claim 12, wherein the predictive model comprises generative artificial intelligence.

17. The method of claim 12, wherein the training the predictive model further comprises:
automatically recognizing features to obtain recognized features, wherein the recognized features expedite the training of the predictive model.

18. A non-transitory machine-readable medium, comprising executable instructions that, when executed by a processing system including a processor, facilitate performance of operations, the operations comprising:
identifying a network operations objective;
obtaining first network monitoring data indicative of a first operational status of a plurality of network devices;
prioritizing the first network monitoring data according to the network operations objective to obtain first prioritized results;
training a predictive model based on the first network monitoring data and the first prioritized results to obtain a trained predictive model; and
evaluating, according to the trained predictive model, second monitoring data indicative of a second operational status of the plurality of network devices to obtain second prioritized results, wherein the network monitoring data is prioritized according to the second prioritized results.

19. The non-transitory machine-readable medium of claim 18, wherein the predictive model comprises generative artificial intelligence.

20. The non-transitory machine-readable medium of claim 18, wherein the training the predictive model further comprises:
automatically recognizing features to obtain recognized features, wherein the recognized features expedite the training of the predictive model.
